(19) United States
(12) Patent Application Publication
(10) Pub. No.: US 2012/0321353 A1
(43) Pub. Date: Dec. 20, 2012

(54) SPEED OR TORQUE TO FILL DEVELOPER STATION

(76) Inventors: Alan E. Rapkin, Pittsford, NY (US); Donald S. Rimai, Webster, NY (US)

(21) Appl. No.: 13/161,573

(22) Filed: Jun. 16, 2011

(51) Int. Cl. G03G 15/08

(52) U.S. Cl. 399/258

(57) ABSTRACT

A system for filling a developer station for an electrophotographic printer including a sump containing developer; an auger in the sump to transport the developer; a shaft on the auger to drive the auger; a motor to drive the shaft of the auger; a mechanism for measuring speed or torque of the motor; a feedback mechanism; a filling mechanism for filling the sump with developer; and wherein filling is stopped or reduced when the speed or the torque reaches a predetermined setting.

### CROSS REFERENCE TO RELATED APPLICATIONS

Reference is made to commonly-assigned copending U.S. patent application Ser. No. ______ (Attorney Docket No. 96594US01/NAB), filed herewith, entitled METHOD FOR FILLING A DEVELOPER STATION, by Rapkin et al.; the disclosure of which is incorporated herein.

### FIELD OF THE INVENTION

The invention relates in general to electrophotographic printers and in particular to filling a developer station for an electrophotographic printer.

### BACKGROUND OF THE INVENTION

In dual component electrophotographic printers, the developer station requires a precise fill amount of developer (toner and magnetic carrier). This is often accomplished in the factory through the use of premeasured packets. This process is similar to the means used in the field by service personnel, however, the use of premeasured packets requires additional packaging and as a result, additional cost over the use of filling from a bulk reservoir.

The problem with filling from a bulk reservoir is insuring that the correct amount of developer is added. A typical means used to control the amount added is the weighing of the station before and after the developer is added. The disadvantage of this method is that the addition of developer requires some manipulation or running of the station which interferes with the accurate measurement of the filling load.

Using prefilled and premeasured packets of developer is time consuming as each packet must first be obtained and opened prior to filling the development station. The packets must first be produced. This requires metering and measuring the correct amount of developer for each packet, filling the packet, sealing the packet, and labeling the packet. It is obvious that the use of packets generates waste in the form of the emptied packets after use that must be processed.

While using packets of premixed developer may be beneficial in the field when servicing a dry electrophotographic print engine, it is not efficient to use such packets in a factory environment. Rather, it is preferable to fill the development station from a bulk supply of developer. Generally, the development station is filled until a specified weight of developer has been deposited into the development station, generally in a sump within the development station designed to hold, mix, and transport the developer.

A standard manner of loading a development station in a factory is to weigh the amount of developer being added to the station. This generally requires that the amount of developer be taken from a bulk supply and weighed until the proper weight is obtained. The developer is then added to the station. Alternatively, a development station can be weighed before and during the adding process until the desired amount of developer has been added. However, this generally requires that the addition of developer be stopped while weighing is in progress. In addition, if too much developer is added, removal of the excess developer is problematic.

It is clear that a more cost effective, less time consuming method of loading precise quantities of developer into a dry electrophotographic development station is needed.

### SUMMARY OF THE INVENTION

This invention provides for an improved method and apparatus for loading a two-component developer into a dry magnetic electrophotographic development station. The method and apparatus include a system for filling a developer station for an electrophotographic printer including a sump containing developer; an auger in the sump to transport the developer; a shaft on the auger to drive the auger; a motor to drive the shaft of the auger; a mechanism for measuring speed or torque of the motor; a feedback mechanism; a filling mechanism for filling the sump with developer; and wherein filling is stopped or reduced when the speed or the torque reaches a predetermined setting.

### BRIEF DESCRIPTION OF THE DRAWINGS

FIG. 1 shows a typical dry electrophotographic printer suitable for use with this invention.

FIG. 2 shows a dry electrophotographic development station containing an inlet for developer and an ammeter for measuring the power needed to drive an auger.

FIG. 3 shows a dry electrophotographic development station containing an inlet for developer and a slip clutch that regulates a valve for metering developer.

### DETAILED DESCRIPTION OF THE INVENTION

The present invention will be directed in particular to elements forming part of, or in cooperation more directly with the apparatus in accordance with the present invention. It is to be understood that elements not specifically shown or described may take various forms well known to those skilled in the art.

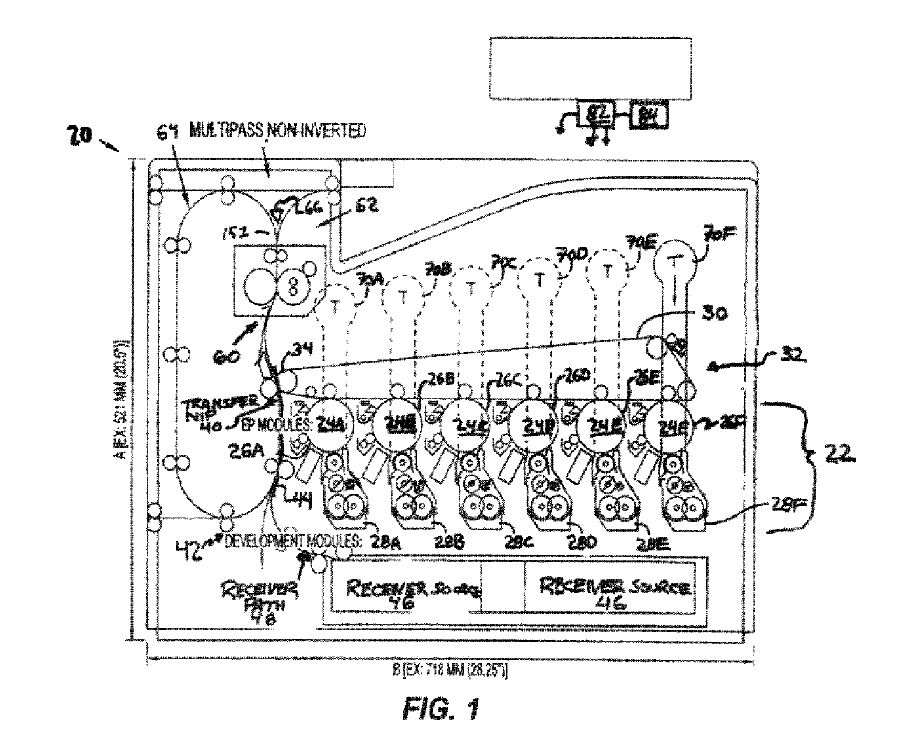

FIG. 1 shows an electrophotographic (EP) printer 20 having a print engine 22 for recording toner images on an intermediate transfer member (ITM) 30 and an intermediate transport system 32 with at least one intermediate transport motor 34 for moving ITM 30 past print engine 22 and to a transfer nip 40. The print engine forms a multi-toner image on intermediate transfer member 30 as it is moved past print engine 22. A receiver transport system 42 moves a receiver 44 along a path 48 from a receiver source 46 through transfer nip 40 so the multi-toner image is transferred from ITM 30 to receiver 44. Receiver transport system 42 then moves receiver 44 and the transferred multi-toner image through a fuser 60 to fuse, fix, or sinter the transferred multi-toner image to receiver 44.

EP printer 20 is controlled by a printer controller 82 which can take the form of a microprocessor, microcontroller, or other such device and appropriate sensors of conventional design. EP printer 20 is shown having dimensions of A×B which are around in one example, 52×718 mm or less, however, it will be appreciated that such dimensions are exemplary and are not limiting.

As is shown in the embodiment of FIG. 1, print engine 22 has a plurality of electrophotographic modules 24A, 24B, 24C, 24D, 24E, and 24F that are provided in tandem and that transfer the various layers of toner necessary to form the multi-toner image. In this embodiment each electrophotographic module 24A, 24B, 24C, 24D, 24E, and 24F contains a single primary imaging member 26A, 26B, 26C, 26D, 26E, and 26F and a single development system 28A, 28B, 28C, 28D, 28E, and 28F to develop toner for ITM 30 or in other embodiments for a receiver 44.

Development stations 28A-28F provide charged toner for use in printing. Generally, toner takes the form of toner particles formed from a material or mixture of materials that can be charged and electrostatically propelled to form an image, pattern, or coating on an oppositely charged imaging member including a photoreceptor, photoconductor, electrostatically-charged, or magnetic surface. Toner is used in an electrophotographic print engine 22 to convert an electrostatic latent image into a visible image or pattern of toner on an ITM 30 and into a visible image on a receiver 44.

Toner particles can have a range of diameters, e.g. less than 8 μm, on the order of 10-15 μm, up to approximately 30 μm, or larger. When referring to particles of toner, the toner size or diameter is defined in terms of the median volume weighted diameter as measured by conventional diameter measuring devices such as a Coulter Multisizer, sold by Coulter, Inc. The volume weighted diameter is the sum of the mass of each toner particle multiplied by the diameter of a spherical particle of equal mass and density, divided by the total particle mass. Toner is also referred to in the art as marking particles or dry ink. In certain embodiments, toner can also comprise particles that are entrained in a wet carrier.

Color toner particles typically have optical densities such that a monolayer coverage (i.e. sufficient application of marking particles such that a microscopic examination would reveal a layer of marking particles covering between 60% and 100% of a primary imaging member) would have a transmission density of between 0.6 and 1.0 in the primarily absorbed light color (as measured using a device such as an X-Rite Densitometer with Status A filters). However, it will be appreciated that these transmission densities are exemplary only and that any conventional range for transmission density or reflectivity can be used with the color toner particles.

Toner can also include clear particles that have the appearance of being transparent or that while being generally transparent impart a coloration or opacity. Such clear toner can provide for example a protective layer on an image or can be used to create other effects and properties on the image.

The various electrophotographic modules each deliver only one type of toner and they can be used in various combinations as desired to print different types of images or to achieve other effects. In the electrophotographic engine shown in FIG. 1 six electrophotographic modules 24A, 24B, 24C, 24D, 24E and 24F enable six different types of toner to be applied in various combinations.

For example, in one application, electrophotographic modules 24A, 24B, 24C, 24D can supply toner particles of one of the four subtractive primary colors that can be applied in various combinations to create images having a full gamut of colors, thus creating an opportunity for fifth and sixth electrophotographic modules 24E and 24F can be used to deliver additional toner types. These additional toner types can include, but are not limited to toner particles that include different subtractive toner colors, clear toner, and raised print, MICR magnetic characters, as well as specialty colors and metallic toners and can deliver toners that are not produced with the basic four subtractive color marking particles. In this example, fifth electrophotographic module 24E and sixth electrophotographic module 24F can deliver a clear toner in a first layer as an overcoat material and in a second layer to form raised textures above the overcoat layer. Here too, it will be understood that these examples are not limiting as fifth electrophotographic module 24E and sixth electrophotographic module 24F can delivery any known type of toner as may be useful or required. It will be appreciated that the organization of toner types with respect to particular electrophotographic modules 24A-24F is provided by way of example and is not limiting.

In particular, the selection of an individual operating or owning (hereafter referred to as the operator) EP printer 20 can provide control signals to controller 82 by way of a user input 84 that printer controller 82 can use to determine which specialty marking particles to apply to an image and where to apply these specially marking particles in order to achieve a particular print outcome. Similarly, input allowing printer controller 82 determines which specialty marking strip like an image and where to apply these specially marking particles can be can take the form of signals from a user input system signals from signals that are associated with a digital image provided for printing.

In the embodiment that is illustrated in FIG. 1, development systems 28A-28F develop the electrostatic latent image on a primary imaging member (PIM) 26A-26F respectively and thereby convert the electrostatic latent image a visible image. Each toner image is transferred, in register, to an intermediate transfer member (ITM) 30 to form a toner transfer image. Method and systems for imparting the charge pattern are well known to those of skill in the art. The ITM can be in the form of a continuous web as shown or can take other forms such as a drum or sheet. It is preferable to use a compliant intermediate transfer member, such as described in the literature, but noncompliant ITMs 30 can also be used.

The multi-toner image formed on ITM 30 is then transferred to a receiver 44, when receiver 44 passes through transfer nip 40 in conjunction with the multi-toner image. In the embodiment that is illustrated in FIG. 1, receiver 44 is provided in the form of receiver sheets that are held in the printer at receiver source 46. However, in other embodiments, receiver 44 can be provided on rolls or other forms. As toner is depleted, the toner concentration of the developer decreases until it becomes necessary to add additional toner to replenish the developer within the development station. This is done by adding toner T from replenishment stations 70A, 70B, 70C, 70D, 70E, and 70F to a developer station 540 contained in electrophotographic modules 24A, 24B, 24C, 24D, 24E, and 24F, respectively.

Receiver 44 enters receiver path 48 so as to travel initially in a counterclockwise direction through receiver path 48. Alternatively, receiver 44 could also be manually input from the left side of the electrophotographic printer 20. The multi-toner image is transferred from the ITM to a receiver 44 and the image bearing receiver then passes through a fuser 60 where the image is fixed to the receiver.

The image then enters a region where the receiver either enters an inverter 62 or continues to travel counterclockwise through a recirculation path 64 that returns receiver 44 to receiver path 48 such that receiver 44 will pass through transfer nip 40 and fuser 60 again, exiting the fuser in fuser exit nip 152. If receiver 44 enters inverter 62, receiver 44 travels clockwise, stops, and then travels counterclockwise back through recirculation path 64 to receiver path 48. This inverts the image, thereby allowing the image to be duplexed. Prior to the inverter is a diverter 66 that can divert receiver 44 from inverter 62 and send receiver 44 along recirculation path 64 in a counterclockwise direction.

Recirculation of a non-inverted receiver 44 allows multiple passes of on a same side of receiver 44 as might be desired if multiple layers of marking particles are used in the image or if special effects such as raised letter printing using large clear toner are to be used. Operation of diverter 66 to enable a repeat of simplex and duplex printing can be visualized using the recirculation path 64.

It should be noted that, if desired, the fuser 60 can be disabled so as to allow a simplex image to pass through the fuser without fusing, if desired. This might be the case if an expanded color balance in simple printing is desired and a first fusing step might compromise color blending during the second pass through the EP engine. Alternatively, a fusing system 60 that merely tacks or sinters, rather than fully fuses, an image and is known in the literature can be used if desired such as when multiple simplex images are to be produced. The image can also be sent through a subsystem that imparts a high gloss to the image, as is known in the art.

The term auger refers to a rotatable member located within the sump 550 contained within an enclosure 18 of the developer station that is used to feed developer onto the development shell, transport developer within the development station, or mix developer such as might be required when replenishing fresh toner to replace toner that has been removed from the developer during development of the electrostatic latent image. The auger 370, can have a single shaft 375 attached to one or more spiral members 376 that move developer. Alternatively, the term auger can also mean any rotatable mechanical means for transporting developer such as a screw mechanism, a paddle mechanism, or a spiral shaft. The shaft typically extends outside the sump at least on one side to enable the shaft to be connected to a drive motor 380.

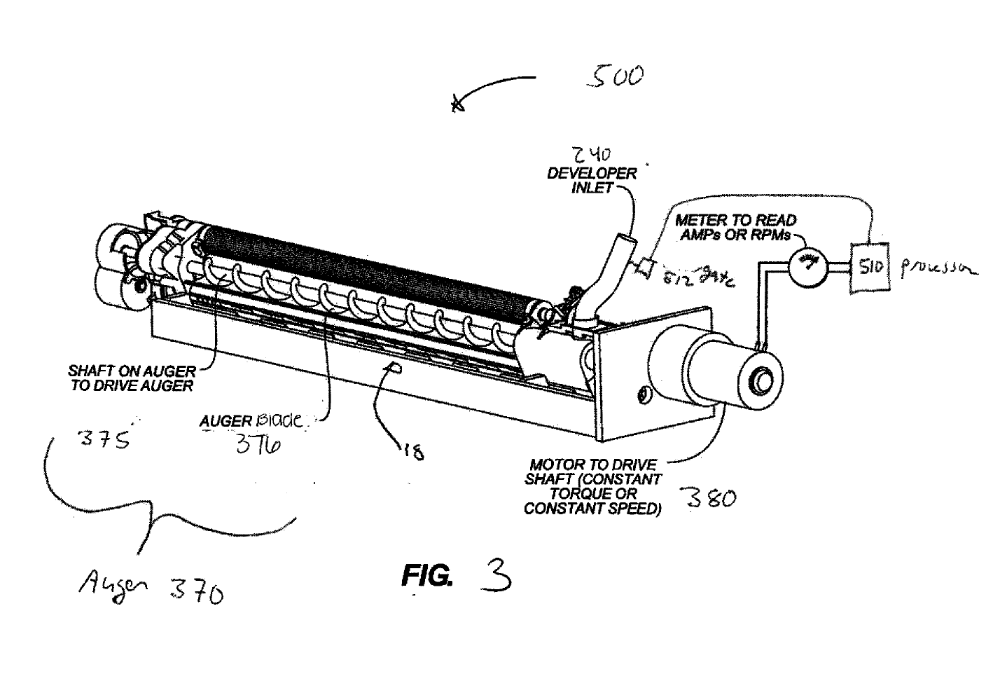

As developer is added to a developer station though a developer inlet 240, the auger shaft 375 is rotated by the drive motor 380 to transport the developer along the length of the sump, as shown in FIG. 3. As the quantity of developer is increased, the auger encounters increasing drag caused by the developer, requiring that the power supplied to the drive motor 380 be increased by increasing either the current or the voltage supplied to the drive motor. The increase drag is especially noticeable when the carrier contains hard magnetic carrier particles or when magnetic hysteresis causes soft magnetic carrier particles to retain some magnetism.

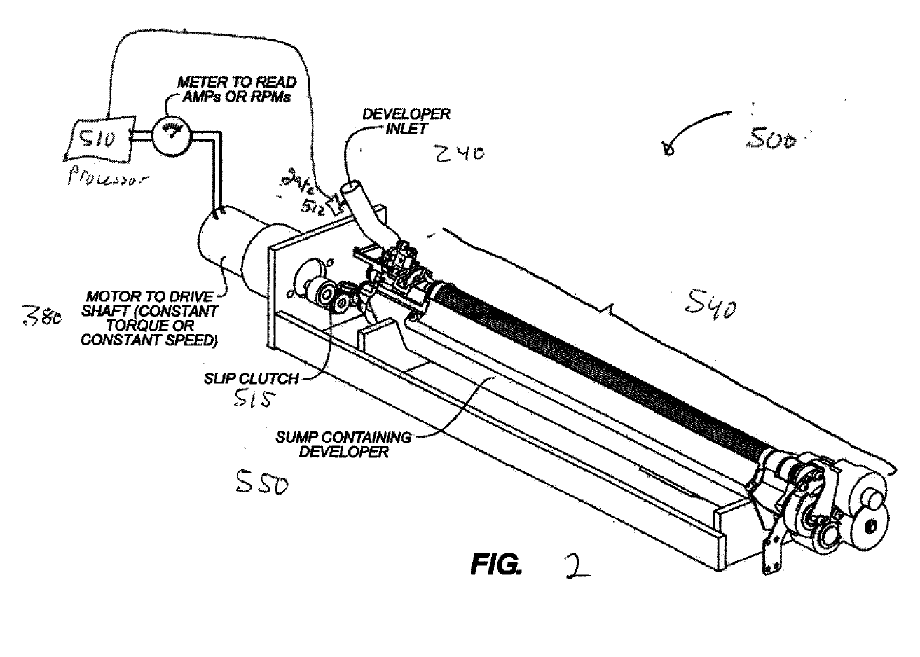

The present invention can be practiced by automatically limiting the filling of the developer station by the system for filling a developer station 500 when a predetermined torque required to rotate the auger is reached. This can be done using a torque meter, an ammeter, or a voltmeter to measure the torque experienced by the auger shaft or the current or voltage required to drive the shaft. The motor or auger shaft can be attached to a governor to automatically increase the power to the motor to compensate for the increased drag as developer is added. When a predetermined torque, current, or voltage is required, a signal is sent to a processor 510 that operates a gate or valve 512 that closes the feed tube so that no more developer enters the development station. Alternatively, a slip clutch 515 can be inserted between the drive motor and auger shaft, as shown in FIG. 2. When a predetermined drag is reached, the clutch disengages causing the gate or valve 512 to close. Drag can also be monitored using a tachometer to measure the speed of the auger shaft at constant voltage and current applied to the motor. If the shaft slows due to increasing drag, the voltage or current applied to the drive motor can be increased to compensate for the increased drag. Alternatively, if the auger speed slows to a predetermined speed, the development station can be considered to be full and further addition of developer is stopped.

Of particular value in practicing this invention is to use a drive motor that is either a constant speed or constant torque drive motor so that the current or voltage applied to the drive motor is automatically increased as the drag is increased until a predetermined current or voltage needed to drive the drive motor has been reached. At that point the filling process is terminated either automatically or through manual intervention, as discussed previously.

In an alternative method of practicing this invention, an operator can manually close the valve or gate when a predetermined voltage, current, or torque is reached.

The present invention has an additional benefit in that, as the drag is increased, the valve can be closed in response to the increasing torque, voltage, or current, thereby reducing the chance of overfilling the developer station or spilling developer due to overfilling the developer station. The ability to monitor the voltage, current, or torque provides a feedback mechanism that can be used to either automatically or manually control or limit the amount of developer that is added to the developer station.

While various sources of developer to be added to the developer station can be used, including small packets of developer, scoops of developer and the like, it is preferable that the developer to be added to the developer station be contained within a large hopper capable of holding sufficient developer to fill multiple developer stations.

It should be noted that the geometry of the station including sump size and auger design, as well as the specific magnetic and physical properties of the carrier, toner, and combined developer and the strength of the magnetic core will all affect the drag. Consequently, the drag needs to be calibrated against the mass of developer added to the development station prior to using this invention. Once calibration has been done, it should not have to be repeated as long as the same type of developer is being used to fill the same type of development station.

The invention has been described in detail with particular reference to certain preferred embodiments thereof, but it will be understood that variations and modifications can be effected within the scope of the invention.

### PARTS LIST

18 enclosure
20 electrophotographic (EP) printer
22 print engine
24A-24F electrophotographic module
26A-26F primary imaging member (PIM)
28A-28F development system
30 intermediate transfer member (ITM)
32 intermediate transport system
34 intermediate transport motor
40 transfer nip
42 receiver transport system
44 receiver
46 receiver source
48 receiver path
60 fuser
62 inverter
64 recirculation path
66 diverter
70A-70F replenishment stations
82 controller
84 user input
152 fuser exit nip
240 developer inlet
370 auger
375 shaft
376 blade
380 motor
500 system for filling a developer station
510 processor
512 gate
515 slip clutch
540 developer station
550 sump containing developer

1. A system for filling a developer station for an electrophotographic printer comprising:
a sump containing developer;
an auger in the sump to transport the developer;
a shaft on the auger to drive the auger;
a motor to drive the shaft of the auger;
a mechanism for measuring speed or torque of the motor;
a feedback mechanism;
a filling mechanism for filling the sump with developer; and
wherein filling is stopped or reduced when the speed or the torque reaches a predetermined setting.

2. The apparatus of claim 1 wherein the sump is filled from a hopper containing developer.

3. The apparatus of claim 1 wherein filling is stopped or reduced by closing a gate.

4. The apparatus of claim 1 wherein said mechanism is an ammeter for measuring a current draw of the motor.

5. The apparatus of claim 1 wherein said mechanism is a slip clutch set at a predetermined torque level.

6. The apparatus of claim 1 wherein said mechanism is a tachometer.

7. The apparatus of claim 1 wherein said mechanism is governor.

8. The apparatus of claim 1 wherein said mechanism is a constant torque motor.

9. The apparatus of claim 1 wherein said mechanism is a constant speed motor.
